(19) United States
(12) Patent Application Publication
(10) Pub. No.: US 2020/0228515 A1
(43) Pub. Date: Jul. 16, 2020

(54) METHODS FOR INCREASING AUTHENTICATION SECURITY

(71) Applicant: Microsoft Technology Licensing, LLC, Redmond, WA (US)

(72) Inventors: Amer A. Hassan, Kirkland, WA (US); Russell Andrew Penar, Highlands Ranch, CO (US); Wei-Chen Chen, Redmond, WA (US)

(21) Appl. No.: 16/247,373

(22) Filed: Jan. 14, 2019

(51) Int. Cl. H04L 29/06; H04L 9/32; H04L 9/30; H04L 9/08

(52) U.S. Cl. CPC H04L 63/083; H04L 9/0869; H04L 9/30; H04L 9/3226

(57) ABSTRACT

Disclosed are embodiments to improve security of authentication credentials. In some aspects, a client device, upon which authentication credentials may be entered cooperates with a server device, which may provide authentication services, to obscure delays between characters of the authentication credentials. This reduces the ability of a nefarious actor to surreptitiously obtain the delays, which may compromise security of a computer account when these delays are used as a signature of a user login process.

### BACKGROUND

As computing as become increasing pervasive in both economic and personal life, the importance of securing computing information has become paramount. Headlines over the past several years have highlighted the dangers of weak computer security, which may lead to information theft, malicious computer use via the installation of malware, and other problems.

Many computer resources are protected via a combination of account name and password. After authentication information matching a valid account name and password for an account is provided, access to certain computer resources associated with an account may be granted. If a nefarious actor were to obtain a valid account name and password for a computer account, those computer resources are at risk of malicious use. Account names and passwords can be compromised. For example, passwords may be recorded by a user, and then the recordings obtained by a nefarious actor. Keyloggers may also be surreptitiously installed, and used to collect information. Therefore, improved methods of protecting this information are desired.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is an overview diagram showing modification of delays between characters of authentication credentials, such as an account name or password.

FIG. 1B is an overview diagram showing modification of delays between characters of authentication credentials, such as an account name and/or password.

FIG. 2A is a diagram showing example message flows that may be implemented in one or more of the disclosed embodiments.

FIG. 2B is a diagram showing example message flows that may be implemented in one or more of the disclosed embodiments.

FIG. 2C is a diagram showing example message formats, one or more of which may be implemented in one or more of the disclosed embodiments.

FIG. 3 shows example data structures, one or more of which may be implemented in some of the disclosed embodiments.

FIG. 4 is an overview diagram of a computer system that implements one or more of the disclosed embodiments.

FIG. 5 is a flowchart for authenticating a user account based on authentication credentials.

FIG. 6 is a flowchart for authenticating an account based on authentication credentials.

FIG. 7 illustrates a block diagram of an example machine 700 upon which any one or more of the techniques (e.g., methodologies) discussed herein may perform.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, a technical problem exists in that if authentication credentials are compromised, they may be used by a nefarious actor to obtain access to resources for which the actor has no right. This may result in substantial consequences, including misuse of those resources for malicious purposes.

The disclosed embodiments provide a technical solution to the technical problem discussed above by, at least in part, providing techniques to further protect authentication credentials. In particular, some authentication systems rely on account names in combination with passwords to authenticate access to a computer account. This authentication, if successful, grants access to any resources authorized for use by the account. To further strengthen these credentials, some of these systems also consider delays that may be included between manual entry of the authentication information. For example, as discussed below, a delay introduced between a first and second character of a username and/or password may be distinctive to how a particular human user types these characters. A series of delays between a corresponding sequence of character pairs form a type of “signature” for this particular human. A different human may type the same characters, but their delay signature may vary from the particular human's signature. Systems relying on these delay signatures may establish criterion for acceptable delays included in an entered authentication credentials. These acceptable delays may be stored with other authentication credentials for an account, such as an account name and/or account password. When an authentication request is received, these acceptable delays are utilized as criterion for determining whether the authentication request succeeds or fails.

Thus, these systems take advantage of this distinctive delay “signature” provided by human typing when judging whether to grant access to account resources. If the delays provided between authentication credential characters are similar to those associated with the account, authentication may succeed, whereas if the delays are outside a range of acceptable values, the authentication may be denied.

One risk of using these delays as part of an authentication system is that they may be observed by nefarious actors and then mimicked in an attempt to gain access to an account. One method of obtaining these delays is to monitor network traffic between a client device attempting to login to an account and a server, such as an authentication server. By monitoring the network traffic, a nefarious actor may observe delays between packets between the client and the server, and from this information infer delays between characters of authentication credentials. Alternatively, message formats passed in clear text on the network may be reverse engineered to obtain delay information that may be encoded in the messages.

To solve this technical problem, the disclosed embodiments augment delays introduced via manual entry of authentication credentials by including additional random delays in authentication credentials. The augmentation of the delays may be provided by a client device upon which the authentication credentials are entered. This augmented authentication data is then provided to another receiving device. Thus, the receiving device receives delay information that is a result of both the delays caused via manual entry and the augmentation performed by the client device. More importantly, the entry delays are not exposed when authentication data is transmitted from the client device to the second device. This makes it more difficult for a nefarious actor to surreptitiously obtain this information.

Since the delays used to augment the manually entered delays may be random, the second device (e.g. authentication server) is unable to compensate for them without some additional information. To solve this problem, the client device and receiving device share a common random number seed value and/or random number generator function. To communicate the shared seed and/or random number generator function between the two devices, a public key of a first device is provided to a second of the devices. The public key allows the second device to encrypt information such as the seed and/or random number function identifier using the public key, and transmit it to the first device. Since the information is encrypted with the public key, it cannot be obtained by observing the encrypted traffic on the network.

Upon receiving the encrypted information, the first device is able to decrypt the information using its private key. Both devices then rely on the shared information when performing account authentication. For example, the client device may use the random number generator seed and/or shared random number generator function to generate a sequence of random numbers, from which a sequence of random delays are derived. These randomly derived delays are then used to augment the delays resulting from manual entry of the authentication information to generate augmented or revised delays.

The revised delays are shared with a server, such as an authentication server. Since the server also knows the random number generator seed and/or function information, the server can reproduce the delays generated at the client device, and subtract out the augmentation of the delays provided by the client, to reveal the original delays introduced via manual entry. These original delays may then be compared to delay criterion stored in an authentication database to authenticate a login attempt.

The sharing of this information between the client and server may be repeated before each authentication attempt in some embodiments. Alternatively, the shared information may remain valid for some defined finite time period. Alternatively, the shared information may remain valid until at least one of the two devices determines that the shared information should be refreshed.

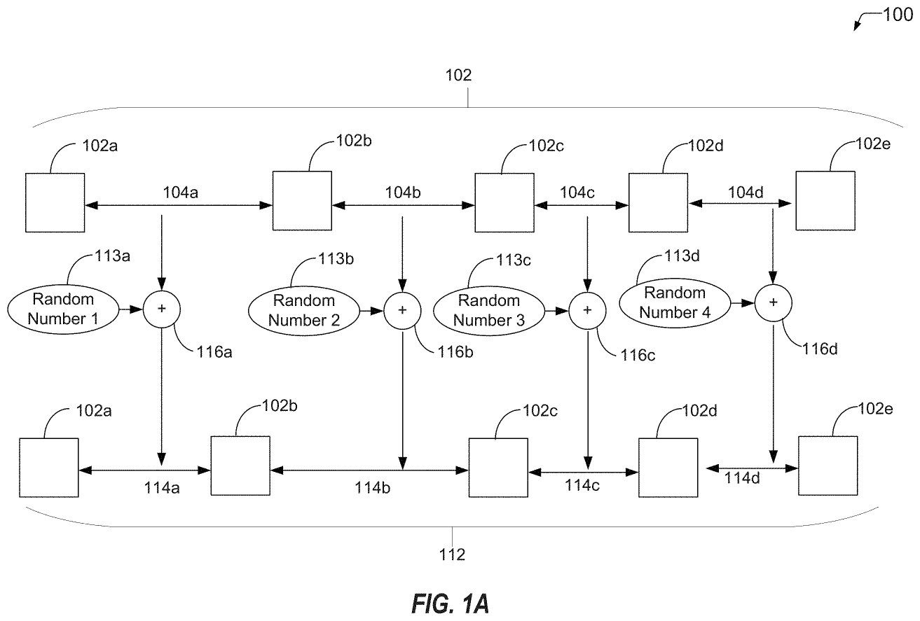

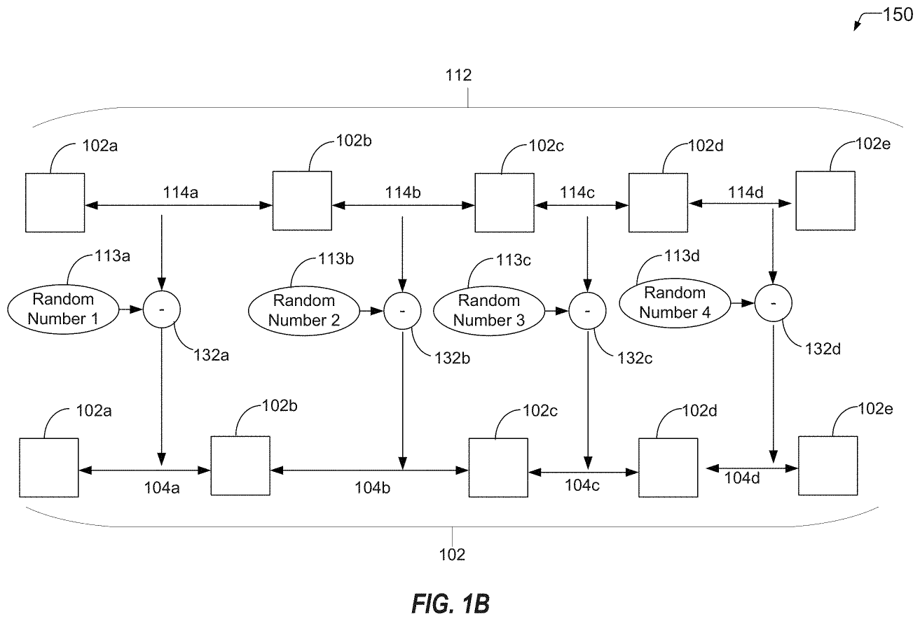

FIG. 1A is an overview diagram showing modification of an authentication credential, such as an account name or password 102. The example account name or password 102 includes five characters, shown as 102a-e. Between entry of each of the characters 102a-e is a time delay, shown as 104a-d. Each of the delays 104a-d may be different or the same as other delays. FIG. 1A is not intended to be drawn to scale, in that relative lengths of each delay 104a-d are not intended to imply a relationship between a size of the delays 104a-d. Embodiments of the present disclosure provide for modification of the delays 104a-d.

For example, the delays 104a-d may each be individually modified by some individual amount. This is shown by the account name or password 112, which represents a modified version of the account name or password 102 and delays 104a-d. As shown in FIG. 1A, four random numbers 113a-d are each added to the delays 104a-d to generate the modified delays 114a-d respectively. As discussed below in more detail, the delays may then be transmitted over a network to a second device, such as an authentication server or another device. By modifying the delays 104a-d to different delays 114a-d before transmission over a network, the original entered delays 104a-d are not exposed or compromised for use by a nefarious actor. Since the random numbers 113a-d may be positive or negative, adding, as described by process FIG. 1A may increase or decrease a duration of the delays 104a-d when generating delays 114a-d. Once a device executing process 100 obtains the delays 114a-d, the delays 114a-d, along with the characters 102a-e may be transmitted to an authentication server, or other device. By modifying the delays 104a-d to delays 114a-d before transmitting the delays to the authentication server, the delays 104a-d may be less susceptible to compromise resulting from the transmission.

FIG. 1B is an overview diagram showing modification of authentication credentials, such as an account name and/or password 102. FIG. 1B shows an inverse modification when compared to the modification shown in FIG. 1A. The process shown in FIG. 1B may be performed, for example, by a server device that has received an authentication credential including the characters 102a-e and delay information indicating delays 114a-d. The device executing process 150 may generate the random numbers 113a-d based on the same seed and/or random number generator function used by the client device described above with respect to FIG. 1A. While the process 100 discussed above with respect to FIG. 1 described adding (via 116a-d) the random numbers 113a-d to the delays 104a-d to generate modified delays 114a-d, FIG. 1B shows subtracting (via 132a-d) the random numbers 113a-d from the delays 114a-d to recreate or rediscover delays 104a-d. Since the random numbers 113a-d may be positive or negative, subtracting, as described by process FIG. 1B may increase or decrease a duration of the delays 114a-d when generating delays 104a-d. Once a device executing process 150 obtains the delays 104a-d, an authentication procedure may be initiated based on the delays 104a-d.

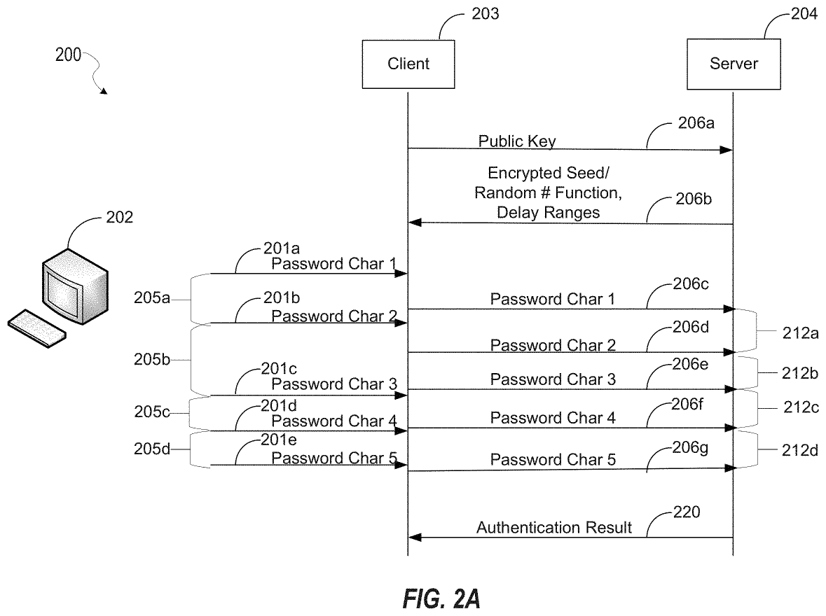

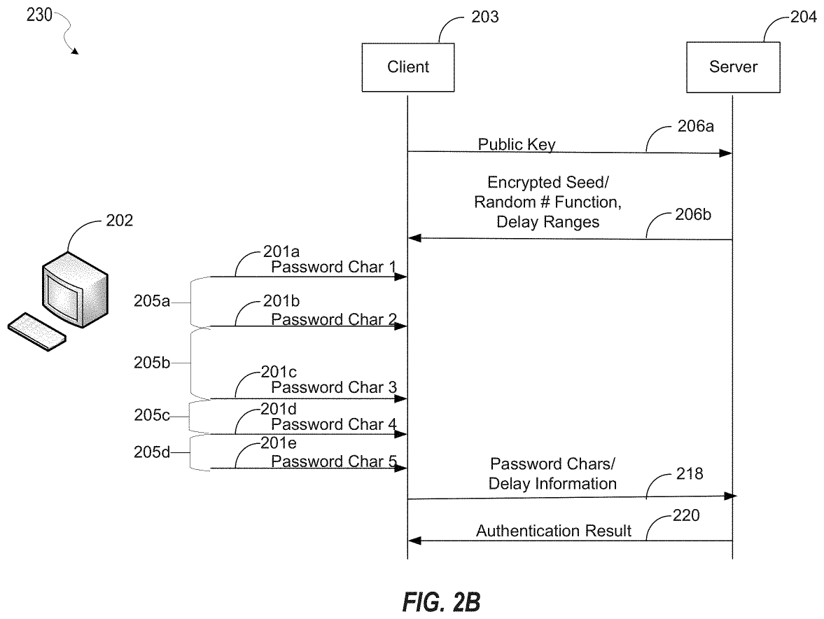

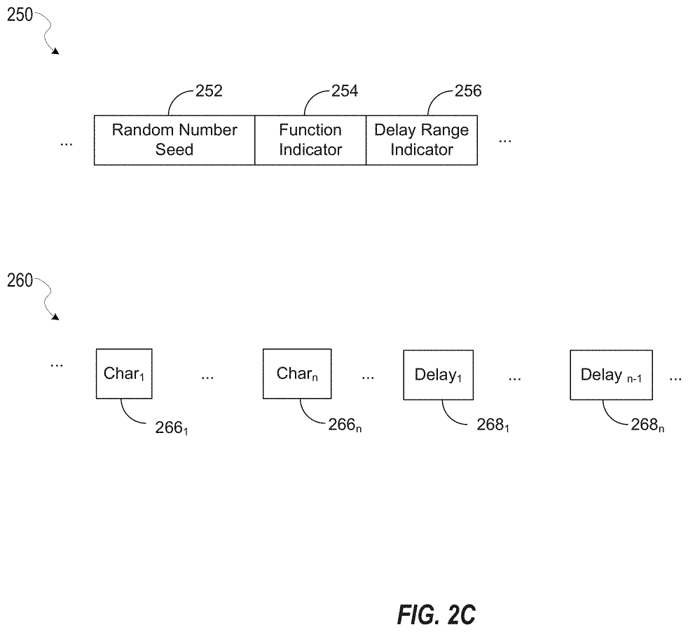

FIG. 2A is a diagram showing message flows that may be implemented in one or more of the disclosed embodiments. The diagram shows an entry device 202, client 203 and a server 204. The entry device 202 and the client 203 may be the same physical device in some embodiments. For example, the entry device may be a keyboard with a direct connection to a client device, such as a laptop, mobile device, or desktop computer. The message flow 200 shows that entry device 202 entering characters for a password 201a-e. The password characters 201a-e are entered with delays 205a-d between pairs of the characters 201a-e.

The client 203 is shown transmitting its public key in a message 206a to the server 204. The server then uses the public key to encrypt information for transmission to the client 203. The information may include one or more of a seed for a random number generator and an identification of a random number generator function. In some aspects, the client 203 and server 204 may share a mapping between identifiers and corresponding random number generators. In these embodiments, the message 206b may include an index or identifier that is mapped, via the shared mapping to a specific implementation of a random number generator, such that both the client 203 and server 204 use the same random number generator function of a set of multiple possible random number generator functions considered in the mapping. Alternatively, the message 206b may include instructions that implement a random number generator function. For example, the message 206 may include intermediate code or even binary code in some aspects that implement the random number generator function.

Upon receiving the encrypted information of message 206b, the client 203 decrypts the message using its private key. The client 203 then generates additional random numbers based on the seed and/or function indicated by the message 206b. The additional random numbers are used by the client 203 to modify the delays 205a-d between the password chars 201a-e. For example, a first random number may be added to the delay 205a to generate a second delay 212a between password characters 206c and 206d, which are transmitted by the client 203 to the server 204. A second random number may be added to the delay 205b to generate another delay 212b. The password character 206e may be transmitted to the server 204 after the delay 212b after the transmission of the password character 206d. Similarly, a third random number may be added to the delay 205c to generate a delay 212c. The delay 212c may be used to determine how long after the transmission of character 206e the next character 206f is transmitted. Finally, a fourth random number is generated by the client 203 and added to delay 205d. The delay 205d is included between transmission of the characters 206f and 206g. Note that while the discussion above describes random number being added to delays, it should be noted that random numbers may, in some aspects, be generated within a range that includes negative numbers. As such, adding such negative random numbers to a delay value has the effect of reducing the delay. These implementations must of course be implemented such that no delay is reduced below a zero value or another threshold value.

The server 204 then considers the password characters 206c-g, and the delays 212a-d when determining whether to authenticate an account. A result of the determination is included in the authentication result message 220 from the server 204 to the client 203.

As discussed in more detail below, because the client and the server share the randomizer configuration information, the server 204 is able to predict the random values the client added to the delays 212a-d. Thus, upon receiving the delays 212a-d, the server may subtract out the random values added to the delays 212a-d to obtain the original entered delays 205a-d. The authentication may then proceed based on the recovered entered delay values 205a-d.

FIG. 2B shows an example of message flows that may be implemented in one or more of the disclosed embodiments. The message flows of FIG. 2B show some similarities to those of FIG. 2A. FIG. 2B also shows the client 203 and server 204. FIG. 2B also shows the public key being communicated to the server 204 via the message 206a. FIG. 2B also shows one or more of a random number seed, random number function identifier, and delay ranges being communicated from the server 204 to the client 203 via the message 206b. FIG. 2B also shows the password characters 201a-e being received by the client device 203, along with delay information 205a-d. FIG. 2B shows the characters 201a-e being included in a message 218 transmitted by the client 203 to the server 204. The message 218 may also include delay information. For example, the delay information included in the message 218 may indicate or indicate the delays 205a-d. The message 218 may be an authentication request in some aspects. FIG. 2B also shows an authentication result message 220 being communicated from the server 204 to the client device 203.

FIG. 2C shows example formats for portions of messages that may be implemented in one or more of the disclosed embodiments. FIG. 2C shows a first message portion 250 that includes a random number seed field 252, function indicator field 254, and a delay range indicator field 256. The message portion 250 may be included in the message 206b discussed above with respect to FIGS. 2A and 2B. The random number seed field 252 stores a seed value to be used in random number generation by a receiving device. By including a random number seed value in a message between a client device and a server device, both devices may generate an equivalent sequence of random number values, which can be used to obscure actual entered delays in authentication credentials, such as an account name and/or password. The function indicator field 254 stores an identifier of a random number generator function. Alternatively, the function indicator field 254 may store instructions that implement a random number generator (e.g. intermediate code, source code, machine code, etc). The delay range indicator 256 stores an indicator of a range for random numbers generated to modify entry delays between characters of authentication credentials. The delay range indicator 256 indicates a range of variability that a client may inject into delays between characters of authentication credentials (e.g. account name and/or password).

The example message portion 260 includes a sequence of ordered characters 266_{1 . . . n}. and delay information including individual delay values 268_{1 . . . n-1}. The example message portion 260 may be included in the message 218 discussed above with respect to FIG. 2B. The message portion 260 may be used to communicate manually entered authentication credentials, such as an account name and/or password, to an authentication server or other device. To illustrate, the delay information 268_{1 . . . n} may be equivalent to the delays 114a-d. In other words, a client device (e.g. 203) may obscure the delays 104a-d by injecting random numbers 113a-d to generate delays 114a-d. These revised delays may then be included in the message 218 and/or message portion 260.

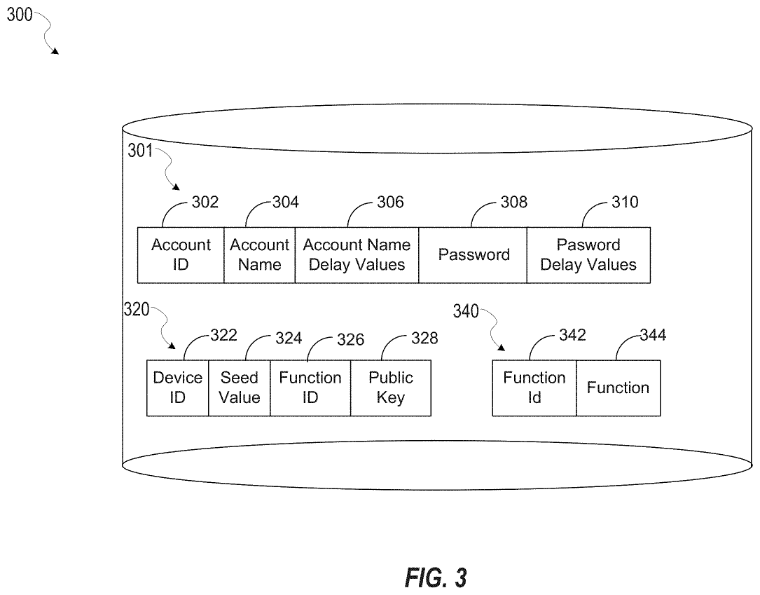

FIG. 3 shows example data structures, one or more of which may be implemented in some of the disclosed embodiments. While the discussion below of FIG. 3 describes the data structures as tables in a relational database, one of skill in the art would understand that in some embodiments, these data structures could be implemented via other means, such as in memory data structures, linked lists, arrays, non-relational databases, or other means.

FIG. 3 shows an account table 300, device table 320, and function table 340. The account table 302 includes an account identifier 302, account name 304, account name delay values 306, password 308, and password delay values 310. The account identifier 302 uniquely identifies an account. The account name field 304 stores a name that identifies the account (e.g. 302). The account name delay values 306 store delay values that may be acceptable when the account name 304 is manually entered. In some aspects, the account name delay values 306 may store a range of delay values between each character of the account name 304 that are acceptable. Acceptable delay values are those that may be present for a successful authentication using the account name 304 with the delay values defined by the account name delay values 306.

The password field 308 stores a password, and the password delay values 310 store acceptable delay values or ranges for characters included in the password field 308. For example, the password delay values 310 may store ranges that encompass the delays 104a-d (or perhaps that do not encompass one or more of the delays 104a-d).

The device table's device id field 322 uniquely identifies a particular device. The seed value field 324 stores a seed value in use for the device identified by the device id field 322. The function identifier field 326 identifies a random number generator function used to generate random delays for the device identified by the device id field 322. The public key 328 stores a public key for the device identified by the device identifier field 322.

The function table 340 includes a function identifier 342 and a function field 344. The function identifier 342 uniquely identifies a function. The function field 344 identifies the function itself. In some aspects, the function field 344 stores instructions that implement the random number generator (e.g. any one or more of intermediate code, source code, machine code, etc). Multiple “rows” of the function table 340 or multiple function fields may store different random number functions. For example, one row may store a hardware based random number generator while another “row” of the function table stores a random number generator based on computational methods, such as pseudorandom number generator. Another row may store a function that generates random numbers from a probability distribution.

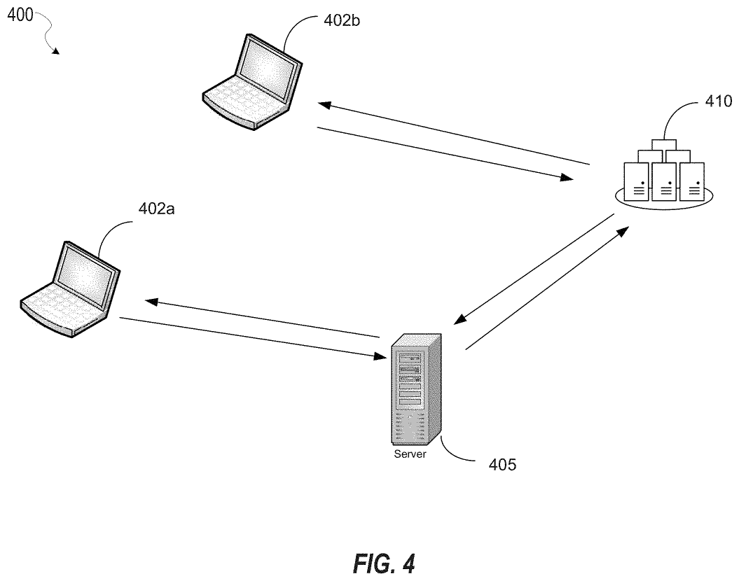

FIG. 4 is an overview diagram of a computer system that implements one or more of the disclosed embodiments. FIG. 4 shows computing devices 402a and 402b, a server 405, and a cloud computing implementation 410. The cloud computing implementation 410 may host an authentication service. The authentication service may compare authentication credentials provided by one or more of the computing device 402b and/or server 405 with credentials stored in an authentication database (e.g. 730). If the credentials match, the cloud computing implementation 410 may establish a session for the user account with the device submitting the authentication credentials.

The embodiments disclosed herein may be implemented by one or more of the computing device 402b and/or server 405. For example, in some aspects, one or more delay profiles discussed above may be configured on, and operate within, a single device, such as the computing device 402b.

In some other aspects, the disclosed embodiments may be implemented on the server device 405. In these embodiments, an account name or password may be entered at the client device 402a. The entered account name and/or password may then be provided to the server device 405 via a network. Additionally, information defining delays between entered characters of the account name and/or password may also be provided to the server device 405 via the network (e.g. information such as the delay values 104a-d shown in FIG. 1A and FIG. 1B). The server device 405 may then apply a delay profile to the received entered password and/or account name to determine whether the delays meet the criterion defined in the delay profile. If the delays between the entered characters meet the requirements of the delay profile, the server device 405 may then provide the account name and/or password to an authentication service implemented by the cloud computing implementation 410. In these aspects, the delay profile may be configured separately on each of the client device 402a and the server device 405. In other embodiments, the delay profile may only be configurable via the server 405 and may be distributed to the client device(s) 402a-b. In some other aspects, the verification of acceptable delay values may be performed by the authentication service itself.

While the example embodiment shown in FIG. 4 and discussed above is described as hosting the authentication service on the describes the authentication service running on the cloud computing implementation 410, in other embodiments, the authentication service could run on any of the client devices 402a or 402b, or the server 405.

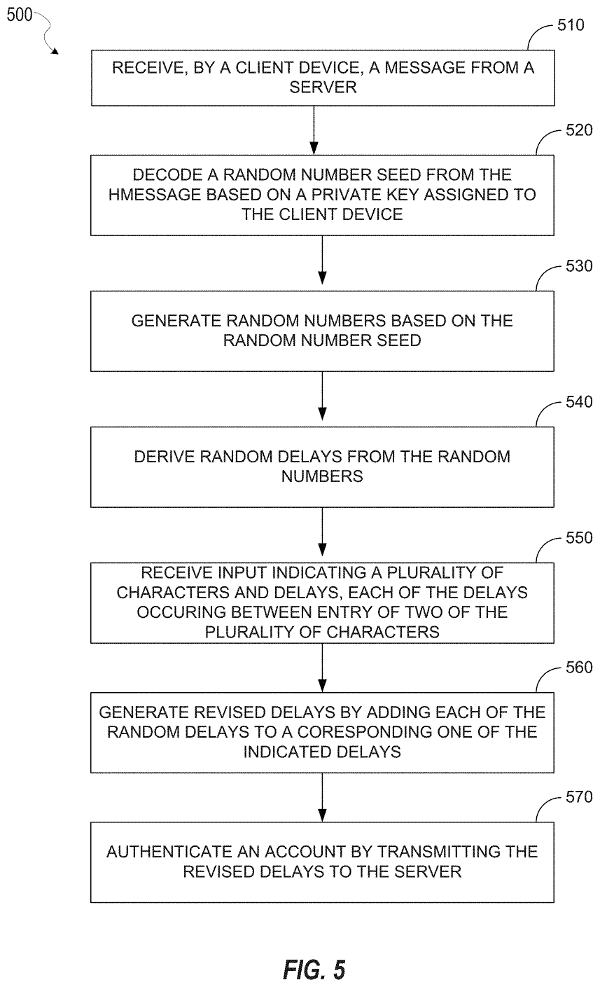

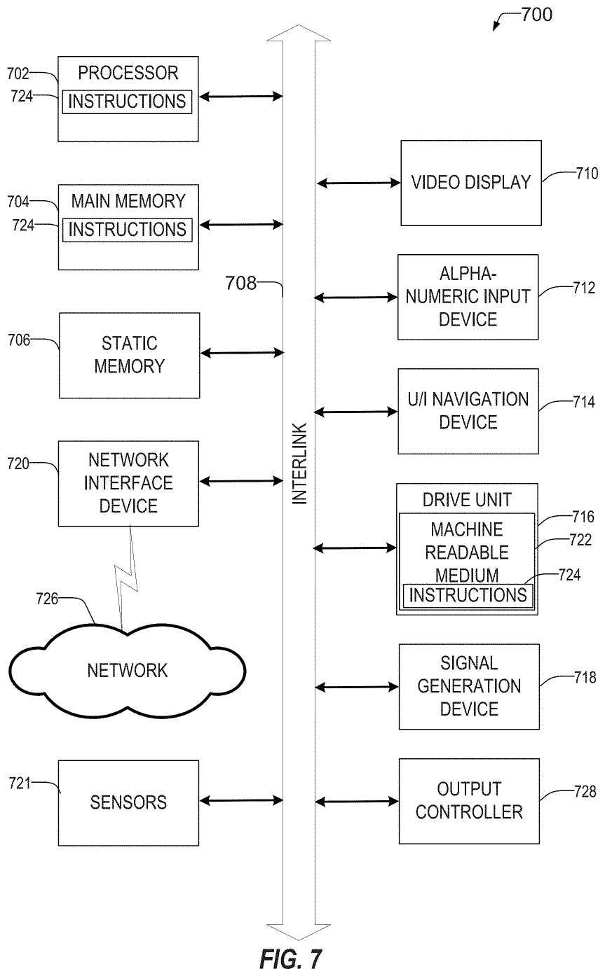

FIG. 5 is a flowchart for authenticating a user account based on authentication credentials. One or more of the functions discussed below with respect to FIG. 5 may be performed by hardware processing circuitry. For example, an electronic memory may store instructions that when executed configure the hardware processing circuitry to perform one or more of the functions discussed below with respect to FIG. 5. In some aspects, process 500 discussed below with respect to FIG. 5 may be performed by a client device, such as any of client devices 402a or 402b. In some aspects, process 500 may be performed by a server, such as server 405. In some aspects, process 500 discussed below with respect to FIG. 5 may be performed by the machine 700 discussed below with respect to FIG. 7. For example, instructions 724 may configure the processor 702 to perform one or more of the functions discussed below with respect to FIG. 5.

In operation 510, a message is received by a client device. The message is received from a server. The client device may be any device upon which a user attempts to login or establish a session with a computer system. The client device may be a laptop, PC, mobile device, desktop, or any computer providing login capability. The server may also be any computer implementing an authentication system. The server may also rely on another device (such as another server) for authentication services. The authentication system provides for establishment of a session upon entry of proper authentication credentials. The established session provides access to computer resources. Access to these resources is unavailable without the established session. In some aspects, the server may be an authentication server, that is configured to compare authentication credentials received from the client device to an authentication data store, and establishing a session if they match.

In operation 520, a random number seed is decoded from the message. The decoding is based on a private key assigned or associated with the client device. The client device is configured with a private key and a public key. The message and/or seed is encoded (by a sender of the message) using the client device's public key. Thus, operation 520 may decode the message using its private key. Use of the public/private key facilitates secure communication between the client device and the server device. In some aspects, an indicator of a random number generation range is decoded from the message.

In operation 530, the client device generates random numbers based on the random number seed. In some aspects, the client device generates the random numbers to be within a random number generation range decoded from the message in operation 520.

In some aspects of operation 530, a separate random number is generated for use to determine a delay modification for each delay between each two characters of an authentication credentials, such as a user name and/or password. The random numbers may be generated within a range. For example, the range may include only positive random numbers, only negative numbers or in other embodiments both positive and negative random numbers.

In operation 540, delay modifiers are derived from the random numbers generated in operation 530. The delay modifiers may be used to augment or modify entry delays resulting from a human entering a user name and/or password when authenticating an account. In some aspects, the delay modifiers are equivalent the random numbers. In some aspects, the delay modifiers may be scaled or shifted versions of the random numbers.

In operation 550, input is received indicating a plurality of characters and a second plurality of delays. Each of the delays occurring between entry of two of the plurality of characters. For example, as discussed above with respect to FIG. 1A and FIG. 1B, authentication credentials such as an account name or password, includes characters (e.g. 102a-102e). Between each of the manually entered characters is a delay (e.g. 104a-d). Note that in some cases, a login may be programmatic. For example, a batch script or program may programmatically initiate a login. The disclosed embodiments are also contemplated to operate under this scenario. In particular, even when a login is programmatic, delays between characters of an authentication credential may also be present. In some cases, a programmatic login may include one or more intentional delays between two corresponding characters to “mimic” a manual entry of authentication credentials.

In operation 560, revised delays are generated by adding each of the delay modifiers to a corresponding one of the indicated (manually entered) delays. As discussed above, random numbers and thus the delay modifiers may be positive or negative, and thus adding the delay modifiers to the manually entered delays may result in a shortening of the entered delay or a lengthening of the entered delays.

In operation 570, an account is authenticated based on the revised delays. Authenticating the account may include transmitting an authentication message (e.g. an authentication request message) to a server, such as an authentication server. A reply may then later be received indicating a result of the authentication. If the authentication is successful, a session may be established for an account associated with the authentication credentials. The session provides access to computing resources, such as CPU processing capability, memory, storage space, network access, I/O bandwidth, and another computing resources, which are unavailable with the session. If the authentication fails, no session is established.

Some aspects of process 500 may include transmitting a second message to the server. The second message indicates the public key of the client device. Thus, in some aspects, the public key of the client device may be distributed via messaging between the client and server.

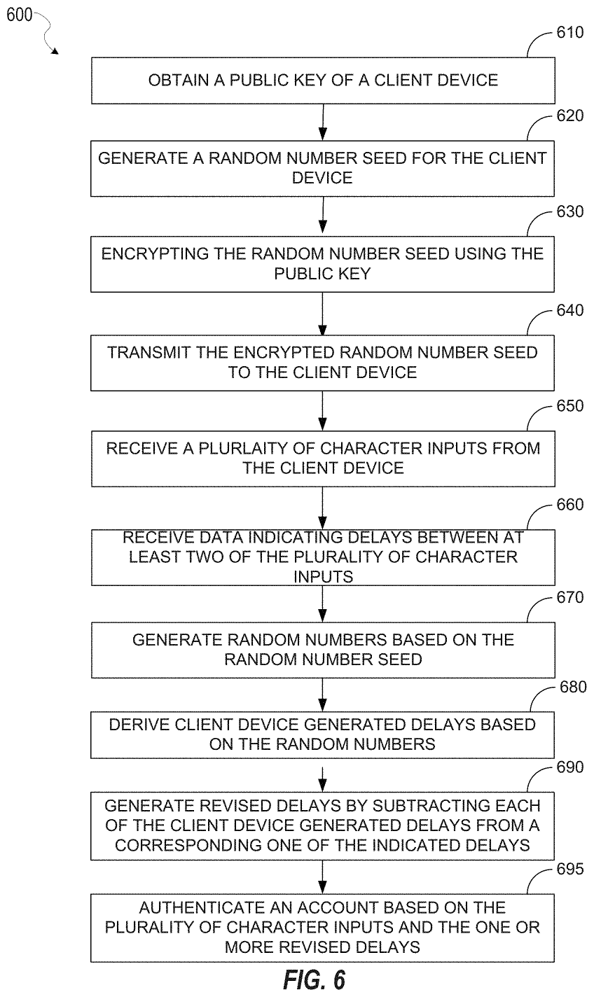

FIG. 6 show a flowchart for authenticating an account based on authentication credentials. One or more of the functions discussed below with respect to FIG. 6 may be performed by hardware processing circuitry. For example, an electronic memory may store instructions that when executed configure the hardware processing circuitry to perform one or more of the functions discussed below with respect to FIG. 6. In some aspects, process 600 discussed below with respect to FIG. 6 may be performed by the machine 700 discussed below with respect to FIG. 7. For example, instructions 724 may configure the processor 702 to perform one or more of the functions discussed below with respect to FIG. 6. In some aspects, process 600 may be performed by an authentication server or other server in communication with a client device that will authenticate using the techniques described herein.

In operation 610, a public key for a client device is obtained. In some aspects, the public key may be read from a database (e.g. 328). In some other aspects, a message may be received from the client device, with the message indicating the pubic key of the client device.

In operation 620, a random number seed for the client device is generated. In some aspects, the seed may be generated based on a value of a hardware clock of a server device. In some other aspects, the seed may be generated via a random number generator.

In operation 630, the random number seed is encrypted using the public key. An encryption function (e.g. Diffie-Hellman, Pretty Good Privacy (PGP), https), may be invoked to encrypt the random number seed using the public key as the encryption key. In some aspects, operation 630 may also include encrypting a function identifier and/or function instructions for implementing the random number generation. As discussed above, a client device and a server may share a mapping between identifiers and different random number generator functions. In some aspects, the client device and server may communicate which random number generator function is used to generate the delays introduced in embodiments of this disclosure. Thus, in some aspects, either an identifier of the function (via the mapping), or the function itself (via instructions implementing the function) are included in the message.

In some aspects, operation 630 includes encrypting an indication of a random number generation range. For example, the indicator may define a lower and upper bound for the random number generation range. Alternatively, predefined identifiers may be mapped to predefined ranges, where one of the predefined identifiers is selected and encrypted in operation 630. The random number generation range defines a range in which the client device is going to generate random numbers and to modify or enhance entered delays.

In operation 640, the encrypted random number seed is transmitted to the client device. In aspects that include an identifier of a random number generator function, or the function itself, these items are also transmitted to the client device in operation 640. These items may be transmitted in a single message or in other aspects, in multiple different messages. In aspects where an indicator of a random number generation range is defined and encrypted in operation 630, the indicator is also transmitted to the client device in operation 640.

In operation 650, a plurality of character inputs are received from the client device. The characters may be received, in some aspects, in an authentication request message from the client device. As discussed above, the character inputs may form at least a portion of an authentication credential, such as an account name and/or password (e.g. 104a-e). These character inputs may be received via a network message from the client device. In some aspects, each character may be transmitted to a server device in a separate message. In some other aspects, multiple characters of the plurality of characters may be included in a single message. In some embodiments, how each character is received may depend on a buffering algorithm used on the client device. For example, client devices utilizing relatively shorter buffer time-out values may transmit more messages generally including fewer characters than other implementations using relatively longer buffer time-out values.

In operation 660, data indicating delays between at least two of the plurality of character inputs is received. In some aspects, the delays may be determined at the device executing process 600, for example, based on delays between reception of two characters of the plurality of characters received in block 660. For example, a first message including a first character may be received at an elapsed time T after a second message is received including a second character. In some aspects, the time T may be used as a delay between the first and second characters.

In some other aspects, separate data indicating the delays may be transmitted by the client device to the server device. For example, the client device may transmit a message including the authentication credentials and data indicating delays between characters of the authentication credentials. For example, in a message that includes multiple characters of the authentication credentials, the delays may be indicated using separate data, since the delay between messages described above carrying the multiple characters may not exist (since all the multiple characters arrived in the same message) in this embodiment.

In operation 670, random numbers are generated based on the random number seed (e.g. 324) for the client device (e.g. 322). Operation 670 may include invoking a random number generator and providing the random number seed as an input parameter. When generating multiple random numbers, the seed may be passed upon a first invocation of the random number generator. Subsequent generation of random numbers may be generated without reinitializing the random number generator with a seed value. He random number generator may maintain a state that it uses to generate sequential random numbers, with the state causing the sequential random numbers to vary “randomly” or “pseudo randomly.” For example, some random number generators generate a predictable sequence of numbers once initialized. However, without knowing the seed value, any sequence of numbers produced by the random number generator appears to be random, in that unless the seed value and/or generation algorithm are know, it is impossible, or at least impractical to predict the next number.

In operation 680, client device generated random numbers are derived from the random numbers. In other words, in the disclosed embodiments, both the client device and server device use the same seed value and random number generator function. Thus, the server is able to predict the delays added by the client device to delays between characters of an authentication credential.

In operation 690, the delays received in operation 660 are revised based on the derived client generated delays. In some aspects, the client device generated delays are subtracted from the delays received in operation 660. Since the client may have added these delays to the manually entered delays (e.g. 104a-e), subtracting these delays is an inverse operation of the operation performed by the client. While the discussion above indicates the client may add delays while the server subtracts delays, other embodiments may switch these operations, with the client subtracting and the server adding (since random numbers may be positive or negative, both adding and/or subtracting may either increase or decrease a size of delay, depending on whether the particular random number being added/subtracted is positive or negative).

In operation 695, an account is authenticated based on the plurality of character inputs and one or more of the revised delays. For example, the character inputs and revised delays may be compared to authentication credentials, such as a stored account name (e.g. 304) and/or password (e.g. 308), and acceptable ranges for delays between characters of those authentication credentials, such as stored in the account name delay values field 306 (to validate delays between characters of an account name) or password delay values field 310 (to validate delays between characters of a password). The delay values to which the revised delays are compared may be considered delay criterion. The delay criterion may specify a separate delay range for an acceptable delay value between each pair of sequential characters included in the authentication credentials. In other words, if the authentication credentials (account name and/or password) includes n characters, the delay criterion may specify up to n−1 delay ranges, one delay range for each pair of sequential character inputs included in the authentication credentials.

In some aspects, operation 695 may include transmitting the authentication credentials and the revised delay values to an authentication server. Operation 695 may also include transmitting a response to the client device indicating a result of the authentication. For example, if the authentication credentials match those in an authentication database (e.g. 300) and the revised delay values match those specified for the account (e.g. 306 and/or 310), then the authentication may be established, and access rights for the account granted to the client device. Otherwise, the authentication request may fail. Rights to one or more computing resources may be granted based on the results of the authentication. For example, if the authentication is successful, a session may be established for the account associated with the credentials. Via the session, computing resources such as files, network capacity, I/O bandwidth, CPU processing capability, memory resources, may be allocated for use by the session. If the authentication is not successful, no such access and/or session is established.

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. In various embodiments, machine 700 may perform one or more of the processes described above with respect to FIGS. 1-6. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Example 1 is a method of authenticating a user comprising: obtaining a public key of a client device; generating a random number seed for the client device; encrypting the random number seed using the public key; transmitting the encrypted random number seed to the client device; receiving a plurality of ordered character inputs from the client device; receiving data indicating delays, each of the delays between two of the plurality of character inputs; generating random numbers based on the random number seed; deriving client device generated delays based on the generated random numbers; generating revised delays by subtracting each of the client device generated delays from a corresponding one of the indicated delays authenticating an account based on the plurality of character inputs and the one or more revised delays.

In Example 2, the subject matter of Example 1 optionally includes wherein obtaining the public key for the client device comprises receiving a message from the client device indicating the public key.

In Example 3, the subject matter of any one or more of Examples 1-2 optionally include wherein the plurality of character inputs are received in one or more messages from the client device.

In Example 4, the subject matter of any one or more of Examples 1-3 optionally include wherein the data indicating the delays are two or more messages from the client device, wherein the indicated delays are equivalent to delays between reception of sequence messages of the two or more messages.

In Example 5, the subject matter of any one or more of Examples 1-4 optionally include wherein authenticating the account comprises evaluating the revised delays against delay criterion stored in a data store, and the method further comprises rejecting the authentication in response to the delay criterion not being met and granting the authentication in response to the revised delays meeting the delay criterion; and transmitting a message to the client device indicating the rejection or the granting of the authentication.

In Example 6, the subject matter of any one or more of Examples 1-5 optionally include generating a random number for each pair of sequential characters in the ordered plurality of character inputs based on the random number seed; determining a delay between each pair of sequential characters in the ordered plurality of character inputs based on the data indicating delays; and for each generated random number, subtracting the generated random number from a respective delay between a respective pair of sequential characters to determine a respective one of the revised delays.

In Example 7, the subject matter of any one or more of Examples 1-6 optionally include selecting, from a group of random number functions, a particular random number function; encrypting an indicator of the selected particular random number function, wherein the encrypted indicator is transmitted to the client device with the random number seed.

In Example 8, the subject matter of Example 7 optionally includes wherein the indicator comprises instructions implementing the random number generator function.

In Example 9, the subject matter of any one or more of Examples 1-8 optionally include wherein the plurality of ordered character inputs represent one or more of an account name and a password for the account.

In Example 10, the subject matter of any one or more of Examples 1-9 optionally include encrypting a random number generation range, wherein the encrypted random number generation range is transmitted to the client device with the random number seed; and generating the random numbers in accordance with the random number generation range.

Example 11 is a method of authenticating a user, comprising receiving, by a client device, a message from a server; decoding a random number seed from the message based on a private key assigned to the client device; generating random numbers based on the random number seed; deriving random delays from the random numbers; receiving input indicating a plurality of ordered characters and delays, each of the delays occurring between entry of two of the plurality of characters; generating revised delays by adding each of the random delays to a corresponding one of the indicated delays; and authenticating an account by transmitting the revised delays to the server.

In Example 12, the subject matter of Example 11 optionally includes wherein the input is received from a keyboard or touchscreen of the client device.

In Example 13, the subject matter of any one or more of Examples 11-12 optionally include transmitting a public key associated with the private key to the server.

In Example 14, the subject matter of any one or more of Examples 11-13 optionally include receiving, from the server, an indication of a random number generator function, and invoking the indicated random number generator function to generate the random numbers.

In Example 15, the subject matter of any one or more of Examples 11-14 optionally include wherein the plurality of ordered characters represent one or more of an account name and a password for the account.

In Example 16, the subject matter of any one or more of Examples 11-15 optionally include decoding a random number generation range from the message, wherein the generation of the random numbers is in accordance with the random number generation range.

Example 17 is a system of authenticating a user comprising: hardware processing circuitry; one or more hardware memories storing instructions that when executed configured the hardware processing circuitry to perform operations comprising: obtaining a public key of a client device; generating a random number seed for the client device; encrypting the random number seed using the public key; transmitting the encrypted random number seed to the client device; receiving a plurality of ordered character inputs from the client device; receiving data indicating delays, each of the delays between two of the plurality of character inputs; generating random numbers based on the random number seed; deriving client device generated delays based on the generated random numbers; generating revised delays by subtracting each of the client device generated delays from a corresponding one of the indicated delays authenticating an account based on the plurality of character inputs and the one or more revised delays.

In Example 18, the subject matter of Example 17 optionally includes wherein obtaining the public key for the client device comprises receiving a message from the client device indicating the public key.

In Example 19, the subject matter of any one or more of Examples 17-18 optionally include wherein the plurality of character inputs are received in one or more messages from the client device.

In Example 20, the subject matter of any one or more of Examples 17-19 optionally include wherein the data indicating the delays are two or more messages from the client device, wherein the indicated delays are equivalent to delays between reception of sequence messages of the two or more messages.

In Example 21, the subject matter of any one or more of Examples 17-20 optionally include wherein authenticating the account comprises evaluating the revised delays against delay criterion stored in a data store, and the operations further comprise rejecting the authentication in response to the delay criterion not being met and granting the authentication in response to the revised delays meeting the delay criterion; and transmitting a message to the client device indicating the rejection or the granting of the authentication.

In Example 22, the subject matter of any one or more of Examples 17-21 optionally include the operations further comprising: generating a random number for each pair of sequential characters in the ordered plurality of character inputs based on the random number seed; determining a delay between each pair of sequential characters in the ordered plurality of character inputs based on the data indicating delays; and for each generated random number, subtracting the generated random number from a respective delay between a respective pair of sequential characters to determine a respective one of the revised delays.

In Example 23, the subject matter of any one or more of Examples 17-22 optionally include the operations further comprising: selecting, from a group of random number functions, a particular random number function; encrypting an indicator of the selected particular random number function, wherein the encrypted indicator is transmitted to the client device with the random number seed.

In Example 24, the subject matter of Example 23 optionally includes wherein the indicator comprises instructions implementing the random number generator function.

In Example 25, the subject matter of any one or more of Examples 17-24 optionally include wherein the plurality of ordered character inputs represent one or more of an account name and a password for the account.

In Example 26, the subject matter of any one or more of Examples 17-25 optionally include the operations further comprising encrypting a random number generation range, wherein the encrypted random number generation range is transmitted to the client device with the random number seed; and generating the random numbers in accordance with the random number generation range.

Example 27 is a system of authenticating a user, comprising: hardware processing circuitry; one or more hardware memories storing instructions that configure the hardware processing circuitry to perform operations comprising: receiving, by a client device, a message from a server; decoding a random number seed from the message based on a private key assigned to the client device; generating random numbers based on the random number seed; deriving random delays from the random numbers; receiving input indicating a plurality of ordered characters and delays, each of the delays occurring between entry of two of the plurality of characters; generating revised delays by adding each of the random delays to a corresponding one of the indicated delays; and authenticating an account by transmitting the revised delays to the server.

In Example 28, the subject matter of Example 27 optionally includes wherein the input is received from a keyboard or touchscreen of the client device.

In Example 29, the subject matter of any one or more of Examples 27-28 optionally include the operations further comprising transmitting a public key associated with the private key to the server.

In Example 30, the subject matter of any one or more of Examples 27-29 optionally include the operations further comprising receiving, from the server, an indication of a random number generator function, and invoking the indicated random number generator function to generate the random numbers.

In Example 31, the subject matter of any one or more of Examples 27-30 optionally include wherein the plurality of ordered characters represent one or more of an account name and a password for the account.

In Example 32, the subject matter of any one or more of Examples 27-31 optionally include the operations further comprising decoding a random number generation range from the message, wherein the generation of the random numbers is in accordance with the random number generation range.

Example 33 is a non-transitory computer readable medium comprising instructions that when executed configured hardware processing circuitry to perform operations comprising: obtaining a public key of a client device; generating a random number seed for the client device; encrypting the random number seed using the public key; transmitting the encrypted random number seed to the client device; receiving a plurality of ordered character inputs from the client device; receiving data indicating delays, each of the delays between two of the plurality of character inputs; generating random numbers based on the random number seed; deriving client device generated delays based on the generated random numbers; generating revised delays by subtracting each of the client device generated delays from a corresponding one of the indicated delays authenticating an account based on the plurality of character inputs and the one or more revised delays.

In Example 34, the subject matter of Example 33 optionally includes wherein obtaining the public key for the client device comprises receiving a message from the client device indicating the public key.

In Example 35, the subject matter of any one or more of Examples 33-34 optionally include wherein the plurality of character inputs are received in one or more messages from the client device.

In Example 36, the subject matter of any one or more of Examples 33-35 optionally include wherein the data indicating the delays are two or more messages from the client device, wherein the indicated delays are equivalent to delays between reception of sequence messages of the two or more messages.

In Example 37, the subject matter of any one or more of Examples 33-36 optionally include wherein authenticating the account comprises evaluating the revised delays against delay criterion stored in a data store, and the operations further comprise rejecting the authentication in response to the delay criterion not being met and granting the authentication in response to the revised delays meeting the delay criterion; and transmitting a message to the client device indicating the rejection or the granting of the authentication.

In Example 38, the subject matter of any one or more of Examples 33-37 optionally include the operations further comprising: generating a random number for each pair of sequential characters in the ordered plurality of character inputs based on the random number seed; determining a delay between each pair of sequential characters in the ordered plurality of character inputs based on the data indicating delays; and for each generated random number, subtracting the generated random number from a respective delay between a respective pair of sequential characters to determine a respective one of the revised delays.

In Example 39, the subject matter of any one or more of Examples 33-38 optionally include the operations further comprising: selecting, from a group of random number functions, a particular random number function; encrypting an indicator of the selected particular random number function, wherein the encrypted indicator is transmitted to the client device with the random number seed.

In Example 40, the subject matter of Example 39 optionally includes wherein the indicator comprises instructions implementing the random number generator function.

In Example 41, the subject matter of any one or more of Examples 33-40 optionally include wherein the plurality of ordered character inputs represent one or more of an account name and a password for the account.

In Example 42, the subject matter of any one or more of Examples 33-41 optionally include the operations further comprising encrypting a random number generation range, wherein the encrypted random number generation range is transmitted to the client device with the random number seed, and generating the random numbers in accordance with the random number generation range.

Example 43 is a non-transitory computer readable storage medium comprising instructions that when executed configure hardware processing circuitry to perform operations comprising: receiving, by a client device, a message from a server; decoding a random number seed from the message based on a private key assigned to the client device; generating random numbers based on the random number seed; deriving random delays from the random numbers; receiving input indicating a plurality of ordered characters and delays, each of the delays occurring between entry of two of the plurality of characters; generating revised delays by adding each of the random delays to a corresponding one of the indicated delays; and authenticating an account by transmitting the revised delays to the server.

In Example 44, the subject matter of Example 43 optionally includes wherein the input is received from a keyboard or touchscreen of the client device.

In Example 45, the subject matter of any one or more of Examples 43-44 optionally include the operations further comprising transmitting a public key associated with the private key to the server.

In Example 46, the subject matter of any one or more of Examples 43-45 optionally include the operations further comprising receiving, from the server, an indication of a random number generator function, and invoking the indicated random number generator function to generate the random numbers.

In Example 47, the subject matter of any one or more of Examples 43-46 optionally include wherein the plurality of ordered characters represent one or more of an account name and a password for the account.

In Example 48, the subject matter of any one or more of Examples 43-47 optionally include the operations further comprising decoding a random number generation range from the message, wherein the generation of the random numbers is in accordance with the random number generation range.

Example 49 is an apparatus for authenticating a user comprising: means for obtaining a public key of a client device; means for generating a random number seed for the client device; means for encrypting the random number seed using the public key; means for transmitting the encrypted random number seed to the client device; means for receiving a plurality of ordered character inputs from the client device; means for receiving data indicating delays, each of the delays between two of the plurality of character inputs; means for generating random numbers based on the random number seed; means for deriving client device generated delays based on the generated random numbers; means for generating revised delays by subtracting each of the client device generated delays from a corresponding one of the indicated delays means for authenticating an account based on the plurality of character inputs and the one or more revised delays.

In Example 50, the subject matter of Example 49 optionally includes wherein obtaining the public key for the client device comprises receiving a message from the client device indicating the public key.

In Example 51, the subject matter of any one or more of Examples 49-50 optionally include wherein the plurality of character inputs are received in one or more messages from the client device.

In Example 52, the subject matter of any one or more of Examples 49-51 optionally include wherein the data indicating the delays are two or more messages from the client device, wherein the indicated delays are equivalent to delays between reception of sequence messages of the two or more messages.

In Example 53, the subject matter of any one or more of Examples 49-52 optionally include wherein authenticating the account comprises evaluating the revised delays against delay criterion stored in a data store, and the apparatus further comprises means for rejecting the authentication in response to the delay criterion not being met and granting the authentication in response to the revised delays meeting the delay criterion; and means for transmitting a message to the client device indicating the rejection or the granting of the authentication.

In Example 54, the subject matter of any one or more of Examples 49-53 optionally include means for generating a random number for each pair of sequential characters in the ordered plurality of character inputs based on the random number seed; means for determining a delay between each pair of sequential characters in the ordered plurality of character inputs based on the data indicating delays; and means for subtracting, for each generated random number, the generated random number from a respective delay between a respective pair of sequential characters to determine a respective one of the revised delays.

In Example 55, the subject matter of any one or more of Examples 49-54 optionally include means for selecting, from a group of random number functions, a particular random number function, means for encrypting an indicator of the selected particular random number function, wherein the encrypted indicator is transmitted to the client device with the random number seed.

In Example 56, the subject matter of Example 55 optionally includes wherein the indicator comprises instructions implementing the random number generator function.

In Example 57, the subject matter of any one or more of Examples 49-56 optionally include wherein the plurality of ordered character inputs represent one or more of an account name and a password for the account.

In Example 58, the subject matter of any one or more of Examples 49-57 optionally include means for encrypting a random number generation range, wherein the encrypted random number generation range is transmitted to the client device with the random number seed; and means for generating the random numbers in accordance with the random number generation range.

Example 59 is an apparatus of authenticating a user, comprising means for receiving, by a client device, a message from a server; means for decoding a random number seed from the message based on a private key assigned to the client device; means for generating random numbers based on the random number seed; means for deriving random delays from the random numbers; means for receiving input indicating a plurality of ordered characters and delays, each of the delays occurring between entry of two of the plurality of characters; means for generating revised delays by adding each of the random delays to a corresponding one of the indicated delays; and means for authenticating an account by transmitting the revised delays to the server.

In Example 60, the subject matter of Example 59 optionally includes wherein the input is received from a keyboard or touchscreen of the client device.

In Example 61, the subject matter of any one or more of Examples 59-60 optionally include means for transmitting a public key associated with the private key to the server.

In Example 62, the subject matter of any one or more of Examples 59-61 optionally include means for receiving, from the server, an indication of a random number generator function, and invoking the indicated random number generator function to generate the random numbers.

In Example 63, the subject matter of any one or more of Examples 59-62 optionally include wherein the plurality of ordered characters represent one or more of an account name and a password for the account.

In Example 64, the subject matter of any one or more of Examples 59-63 optionally include means for further comprising decoding a random number generation range from the message, wherein the generation of the random numbers is in accordance with the random number generation range.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory; etc.

I claim:

1. A system of authenticating a user comprising:
hardware processing circuitry;
one or more hardware memories comprising instructions that when executed by the hardware processing circuitry to perform operations comprising:
obtaining a public key of a client device;
generating a random number seed for the client device;
encrypting the random number seed using the public key;
transmitting the encrypted random number seed to the client device;
receiving a plurality of ordered character inputs from the client device;
receiving data indicating delays, each of the delays between two of the plurality of character inputs;
generating random numbers based on the random number seed;
deriving client device generated delays based on the generated random numbers;
generating revised delays by subtracting each of the client device generated delays from a corresponding one of the indicated delays; and
authenticating an account based on the plurality of character inputs and the one or more revised delays.

2. The system of claim 1, wherein obtaining the public key for the client device comprises receiving a message from the client device indicating the public key.

3. The system of claim 1, wherein the plurality of character inputs are received in one or more messages from the client device.

4. The system of claim 1, wherein the data indicating the delays are two or more messages from the client device, wherein the indicated delays are equivalent to delays between reception of sequence messages of the two or more messages.

5. The system of claim 1, wherein authenticating the account comprises evaluating the revised delays against delay criterion stored in a data store, and the operations further comprising rejecting the authentication in response to the delay criterion not being met and granting the authentication in response to the revised delays meeting the delay criterion; and transmitting a message to the client device indicating the rejection or the granting of the authentication.

6. The system of claim 1, the operations further comprising:
generating a random number for each pair of sequential characters in the ordered plurality of character inputs based on the random number seed;
determining a delay between each pair of sequential characters in the ordered plurality of character inputs based on the data indicating delays; and
for each generated random number, subtracting the generated random number from a respective delay between a respective pair of sequential characters to determine a respective one of the revised delays.

7. The system of claim 1, the operations further comprising:
selecting, from a group of random number functions, a particular random number function;
encrypting an indicator of the selected particular random number function, wherein the encrypted indicator is transmitted to the client device with the random number seed.

8. The system of claim 7, wherein the indicator comprises instructions implementing the random number generator function.

9. The system of claim 1, wherein the plurality of ordered character inputs represent one or more of an account name and a password for the account.

10. The system of claim 1, the operations further comprising encrypting an indicator of a random number generation range, wherein the encrypted indicator of the random number generation range is transmitted to the client device with the random number seed, wherein the generation of the random numbers by the client device is in accordance with the indicated random number generation range.

11. A method of authenticating a user comprising:
obtaining a public key of a client device;
generating a random number seed for the client device;
encrypting the random number seed using the public key;
transmitting the encrypted random number seed to the client device;
receiving a plurality of ordered character inputs from the client device;
receiving data indicating delays, each of the delays between two of the plurality of character inputs;
generating random numbers based on the random number seed;
deriving client device generated delays based on the generated random numbers;
generating revised delays by subtracting each of the client device generated delays from a corresponding one of the indicated delays; and
authenticating an account based on the plurality of character inputs and the one or more revised delays.

12. The method of claim 11, wherein the data indicating the delays are two or more messages from the client device, wherein the indicated delays are equivalent to delays between reception of sequence messages of the two or more messages.

13. The method of claim 11, wherein authenticating the account comprises evaluating the revised delays against delay criterion stored in a data store, and the method further comprises rejecting the authentication in response to the delay criterion not being met and granting the authentication in response to the revised delays meeting the delay criterion; and transmitting a message to the client device indicating the rejection or the granting of the authentication.

14. The method of claim 11, further comprising:
generating a random number for each pair of sequential characters in the ordered plurality of character inputs based on the random number seed;
determining a delay between each pair of sequential characters in the ordered plurality of character inputs based on the data indicating delays; and
for each generated random number, subtracting the generated random number from a respective delay between a respective pair of sequential characters to determine a respective one of the revised delays.

15. The method of claim 11, further comprising:
selecting, from a group of random number functions, a particular random number function; and
encrypting an indicator of the selected particular random number function, wherein the encrypted indicator is transmitted to the client device with the random number seed.

16. The method of claim 15, wherein the indicator comprises instructions implementing the random number generator function.

17. The method of claim 11, wherein the plurality of ordered character inputs represent one or more of an account name and a password for the account.

18. The method of claim 11, further comprising encrypting an indicator of a random number generation range, wherein the encrypted indicator of the random number generation range is transmitted to the client device with the random number seed; and generating the random numbers in accordance with the indicated random number generation range.

19. A system for authenticating a user, comprising:
hardware processing circuitry;
one or more hardware memories storing instructions that when executed by the hardware processing circuitry to perform operations comprising:
receiving, by a client device, a message from a server;
decoding a random number seed from the message based on a private key assigned to the client device;
generating random numbers based on the random number seed;
deriving random delays from the random numbers;
receiving input indicating a plurality of ordered characters and delays, each of the delays occurring between entry of two of the plurality of characters;
generating revised delays by adding each of the random delays to a corresponding one of the indicated delays; and
authenticating an account by transmitting the revised delays to the server.

20. The system of claim 19, the operations further comprising transmitting a public key associated with the private key to the server.

21. The system of claim 19, the operations further comprising receiving, from the server, an indication of a random number generator function, and invoking the indicated random number generator function to generate the random numbers.

22. The system of claim 19, wherein the plurality of ordered characters represent one or more of an account name and a password for the account.

23. The system of claim 19, the operations further comprising decoding an indicator of a random number generation range from the message, wherein the generation of the random numbers is in accordance with the indicated random number generation range.

24. A method for authenticating a user, comprising:
receiving, by a client device, a message from a server;
decoding a random number seed from the message based on a private key assigned to the client device;
generating random numbers based on the random number seed;
deriving random delays from the random numbers;
receiving input indicating a plurality of ordered characters and delays, each of the delays occurring between entry of two of the plurality of characters;
generating revised delays by adding each of the random delays to a corresponding one of the indicated delays; and
authenticating an account by transmitting the revised delays to the server.

25. The method of claim 24, the operations further comprising receiving, from the server, an indication of a random number generator function, and invoking the indicated random number generator function to generate the random numbers.

26. The method of claim 24, wherein the plurality of ordered characters represent one or more of an account name and a password for the account.

27. The method of claim 24, the operations further comprising decoding an indicator of a random number generation range from the message, wherein the generation of the random numbers is in accordance with the random number generation range.

28. An apparatus comprising:
means for obtaining a public key of a client device;
means for generating a random number seed for the client device;
means for encrypting the random number seed using the public key;
means for transmitting the encrypted random number seed to the client device;
means for receiving a plurality of ordered character inputs from the client device;
means for receiving data indicating delays, each of the delays between two of the plurality of character inputs;
means for generating random numbers based on the random number seed;
means for deriving client device generated delays based on the generated random numbers;
means for generating revised delays by subtracting each of the client device generated delays from a corresponding one of the indicated delays; and
means for authenticating an account based on the plurality of character inputs and the one or more revised delays.

29. The apparatus of claim 28, wherein the means for obtaining the public key for the client device is configured to receive a message from the client device indicating the public key.

30. The apparatus of claim 28, wherein the plurality of character inputs are received in one or more messages from the client device.

31. The apparatus of claim 28, wherein the data indicating the delays are two or more messages from the client device, wherein the indicated delays are equivalent to delays between reception of sequence messages of the two or more messages.
